(19) United States
(12) Patent Application Publication
(10) Pub. No.: US 2010/0154599 A1
(43) Pub. Date: Jun. 24, 2010

(54) MOBILE CONTROL DEVICE FOR POWER WRENCHES

(76) Inventor: Marc Gareis, Leonberg (DE)

Correspondence Address: COLLARD & ROE, P.C., 1077 NORTHERN BOULEVARD, ROSLYN, NY, 11576, US

(21) Appl. No.: 12/452,931

(22) PCT Filed: Jul. 29, 2008
(86) PCT No.: PCT/DE2008/001222

§ 371 Date: Jan. 29, 2010

(30) Foreign Application Priority Data
Jul. 31, 2007 (DE) 10 2007 036 328.3

(51) Int. Cl. B25B 21/00

(52) U.S. Cl. 81/54

(57) ABSTRACT

The invention relates to a mobile control device (10) for power wrenches, comprising at least one display unit (11) and at least one input element (12a, 12b, 13a, 13b, 13c). The control device (10) is characterized by a mechanism (14) for receiving a contactless mobile data carrier (31) and a data carrier transceiver (33) which establishes a data carrier connection (34) to exchange data with a contactless mobile data carrier (31) that is placed in the receiving mechanism (14). The invention further relates to uses of the mobile control device (10) for remote controlling differently designed power wrenches (40, 50, 60) and/or exchanging data with such a power wrench (40, 50, 60) or at least recording data of such a power wrench (40, 50, 60). The disclosed mobile control device (10) for power wrenches is particularly suitable for use in harsh environmental conditions.

The present invention relates to a mobile control device for power wrenches according to the preamble of the independent claim. The invention further relates to applications of the mobile control device for power wrenches.

### BACKGROUND OF THE INVENTION

DE 201 13 184 U1 discloses an electrically operated power wrench which, according to one embodiment, can be controlled via a remote control. The remote control can be connected with the power wrench via a radio link or by cable. The remote control comprises a permanently integrated data storage that can be read out, and onto which data can be written, via a computer interface integrated in the remote control. The remote control comprises input elements as well as a display.

DE 44 23 520 A1 describes a hydraulically operated power wrench, comprising a hydraulically operated piston-cylinder unit and a source of motive energy for the piston-cylinder unit, which can be connected one with the other via flexible cords. The source of motive energy comprises a receiving mechanism, intended to receive a mobile data carrier, by which the mobile data carrier can be removably connected with the source of motive energy. In addition to an integrated circuit, the mobile data carrier comprises a key adapted for being connected with the mobile data carrier, which cannot be detached from the mobile data carrier unless the mobile data carrier is seated in the receiving mechanism. The key fits into a coded keyhole element so that a given mobile data carrier can be assigned unambiguously to a given piston-cylinder unit. Transmission of the driving power from the source of motive energy to the piston-cylinder unit starts only when the key has been detached from the mobile data carrier and has been inserted into the keyhole element on the piston-cylinder unit. The source of motive energy can be connected with an external logging unit via a connection cable for documentation purposes.

DE 10 2004 059 859 B3 describes a hydraulic pump for a hydraulically operated tool. The control device described by that application is integrated undetachably in the hydraulic pump. The control device comprises a system-integrated commercially available memory card. The memory card can be read out to a PC, and data can be written into that card, via a communication interface or by removal of the card and insertion of the card into a different slot.

DE 10 2004 043 146 B3 describes a hydraulically operated power wrench that can be controlled via a remote control. The remote control activates the motor switch to switch on the drive motor when certain defined operating conditions are fulfilled. In order to prevent switching-on of the drive motor as long as it is still in driving connection with an alternate jack, a limit switch is provided in the area of an operating lever which ensures that connection with the remote control will be established only when the driving connection with the alternate jack is interrupted. The remote control comprises four operating keys and a display.

DE 196 47 813 A1 discloses a power wrench that can be wirelessly connected with an electronic evaluation system via an infrared interface. The electronic evaluation system as such is connected with an electronic input system that comprises a keyboard and a display.

WO 2006/056187 A1 describes a hydraulic power wrench adapted to be controlled by means of a remote control of simple design. The remote control comprises 3 keys, one key for automatic operation, a second key for switching on and a third key for switching off the wrench.

WO 03/024670 A1 shows a hydraulic power wrench adapted to be controlled by a remote control. The remote control is connected by cable with a rotary sensor and a cutoff device for the drive. The input elements of the remote control consist of two relatively big keys marked by arrows.

JP 8118251 A discloses a hand-operated torque wrench with electric components comprising at least a display on which are displayed the actual values of the screwed connection being produced. The electronic components comprise an infrared interface that connects the electronics contained in the hand-operated torque wrench with a remote control. The remote control comprises operating elements and a display. The remote control as such can be connected with a PC via cable.

Further, DE 20 2005 002 748 U1 describes a hand-operated torque wrench on which a data carrier is arranged. The data carrier is designed as an RFID chip undetachably connected with the torque wrench. The torque wrench does not contain any electric or electronic components that would on the one hand record measured data or, on the other hand, exchange information with the RFID chip. However, servicing intervals for the torque wrench, for example, may be stored in the RFID chip. Further, it is possible to monitor and to record motion profiles of the torque wrench during use.

DE 10 2005 015 688 A1 describes a screw equipped with a sensor for recording the biasing force of the screw. The sensor is a PMT sensor or an ultrasound sensor, for example. The screw further contains a data carrier in the form of an RFID chip. Both the sensor and the data carrier are undetachably connected with the screw. After tightening of the screw, the biasing force measured by the PMT sensor is written into a memory of the RFID chip. The data so stored can be either displayed on an external display unit, or can be stored or printed out on an external recording unit.

JP 2003-139268 A describes a valve with an associated RFID chip containing information on the torque required for opening and closing the valve. After connection of the valve electronics with a valve control device the information is transmitted to control the control device in response to the information stored.

A universal remote control, designed for the control of consumer electronics, into which a mobile data carrier can be inserted has been known for example from JP 2001-086575 A. Prior to being inserted into the remote control, which comprises operating elements and a display, the data required by the universal remote control for the remote control of specific types of consumer electronics are written onto the data carrier.

A description of the RFID technology is available under URL: http://de.wikipedia.org/wiki/Radio_Frequence_Identification.

Now, it is the object of the present invention to provide a mobile control device for power wrenches that can be operated easily and safely, especially in rough environmental conditions. Further, the invention is to specify applications for the control device for power wrenches.

The invention achieves that object by the features defined in the independent claim.

### DISCLOSURE OF THE INVENTION

The invention relates to a mobile control device for power wrenches comprising at least one display unit and at least one input element. The control device for power wrenches according to the invention is characterized by a mechanism for receiving a contactless mobile data carrier and a data carrier transceiver which establishes a data carrier connection for the exchange of data with a contactless mobile data carrier located in the receiving mechanism.

The mobile control device for power wrenches according to the invention on the one hand permits differently designed power wrenches to be controlled. In addition, the invention provides for data transmission between a power wrench of the described type and the control device for power wrenches according to the invention, which is especially intended for supplying nominal values of a screwed connection to be produced and for recording actual values of a screwed connection produced.

Particular flexibility of the mobile control device for power wrenches according to the invention results from the use of a contactless mobile data carrier that is inserted into the receiving mechanism. Due to that feature, it is not necessary to store further software or other operating modes in the mobile control device for power wrenches, except for a small operating program for the mobile control device for power wrenches according to the invention, because the data stored on the contactless mobile data carrier will at any time ensure proper adaptation to the momentary operating conditions.

The mobile control device for power wrenches is especially well suited for use in harsh environmental conditions where considerable risks of contamination are to be expected. When contamination occurs, the mobile data carrier prevents special disadvantages insofar as there is absolutely no risk of contamination of any contacts. Even if the contactless mobile data carrier should drop onto the unsurfaced ground of a site, which normally would result in considerable contamination of the contactless mobile data carrier, this will have no detrimental influences on any subsequent use of the data carrier in the control device for power wrenches.

Advantageous further developments and embodiments of the control device for power wrenches are apparent from the dependent claims.

A first embodiment provides that the receiving mechanism comprises two oppositely arranged card slots that permit the contactless mobile data carrier to be pushed through the slots. Due to that feature any dirt that may have entered the receiving mechanism can be removed again.

According to another embodiment, the receiving unit comprises at least one spring element for locating the contactless mobile data carrier in the receiving mechanism. When realized as a plastic spring element the spring element can be produced at especially low cost.

An especially advantageous embodiment provides that the data carrier transceiver is adapted for the exchange of data with the contactless mobile data carrier in the form of an RFID chip. Being produced by mass production processes, such an RFID chip is available at particularly low cost, and in addition it meets all requirements of the intended application. Especially, the RFID chip is prepared for contactless data exchange and for contactless transmission of energy to the RFID chip.

According to a further development of the mobile control device for power wrenches according to the invention a work light is provided which preferably comprises an LED or a cluster LED. Light-emitting diodes are comparatively robust and are therefore especially well suited for use in harsh environmental conditions. One design of that particular further development provides that the mobile control device for power wrenches comprises a timing element that determines the time of persistence of the work light. Accordingly, the work light can be started by a touch key function and automatic switching-off will be guaranteed.

According to one embodiment, at least one input element is designed as an operating key which has a specifically defined pressure point. Preferably, the surface of the at least one operating key is sized so that the operating key can be operated with the hands in work gloves. The at least one operating key may for example be linked with a remote control function for a power wrench.

According to another embodiment, at least one input element is designed as at least one membrane key for the input of data into the control device for power wrenches or for the control of the mobile control device for power wrenches. Input and/or control of the control device for power wrenches normally is effected without work gloves so that a membrane keypad will be sufficient for that function. Especially, cleaning of the membrane keypad is particularly easy.

Operation of the mobile control device for power wrenches is facilitated by a beveled and/or a recessed portion on at least one side of the housing surface. The beveled and/or the recessed portion is provided especially in the area of the at least one pushbutton so that the pushbuttons can be easily operated by the thumb with the hand gripping the mobile control device for power wrenches. Easy handling of the mobile control device for power wrenches according to the invention is further assisted by recessed grips provided on at least one side of the bottom of the housing.

One embodiment provides that the mobile control device for power wrenches comprises a plug-in connector suited to receive a corresponding plug-in connector of a first connection line provided for connecting the mobile control device for power wrenches with a power wrench. Further, the mobile control device for power wrenches may comprise a plug-in connector designed as a charging socket for an accumulator. The accumulator is intended as energy supply for the mobile control device for power wrenches according to the invention.

Data exchange and/or remote control of the power wrench may be effected by a wired connection or else by wireless connection. For establishing the connection, the mobile control device for power wrenches according to the invention comprises a first control device transceiver for wireless or wired data exchange with a corresponding power wrench transceiver arranged in the power wrench.

According to a further development, the mobile control device for power wrenches according to the invention comprises a second control device transceiver for wireless or wired exchange of data with a corresponding transceiver of a stationary unit that is arranged in a stationary system. The stationary unit is realized for example as a larger stationary data processing system that manages the data of a plurality of power wrenches.

The mobile control device for power wrenches according to the invention may be adapted especially for use for the exchange of data and/or for the remote control of a hydraulically or pneumatically operated power wrench.

Further, the mobile control device for power wrenches according to the invention may be adapted especially for use at least for the exchange of data with a battery-driven power wrench and/or the remote control of the latter.

In addition, the mobile control device for power wrenches according to the invention may even be adapted for use for the exchange of data with a hand-operated power wrench, or at least for the output or input of data of the hand-operated power wrench.

Additional advantageous further developments and embodiments of the mobile control device for power wrenches according to the invention will be apparent from the specification that follows. Certain embodiments of the invention are illustrated in the drawing and will be described in more detail in the description that follows.

### BRIEF DESCRIPTION OF THE FIGURES

FIG. 1 shows a perspective representation, viewed from one side and from the rear, of a mobile control device for power wrenches according to the invention;

FIG. 2 shows a perspective representation, viewed from the other side and from the front of the mobile control device for power wrenches according to the invention;

FIG. 3 shows a block diagram of the mobile control device for power wrenches according to the invention;

FIGS. 4a-4c show differently designed power wrenches; and

FIG. 5 shows part of a block diagram of a stationary system.

### DETAILED DESCRIPTION OF THE EMBODIMENTS

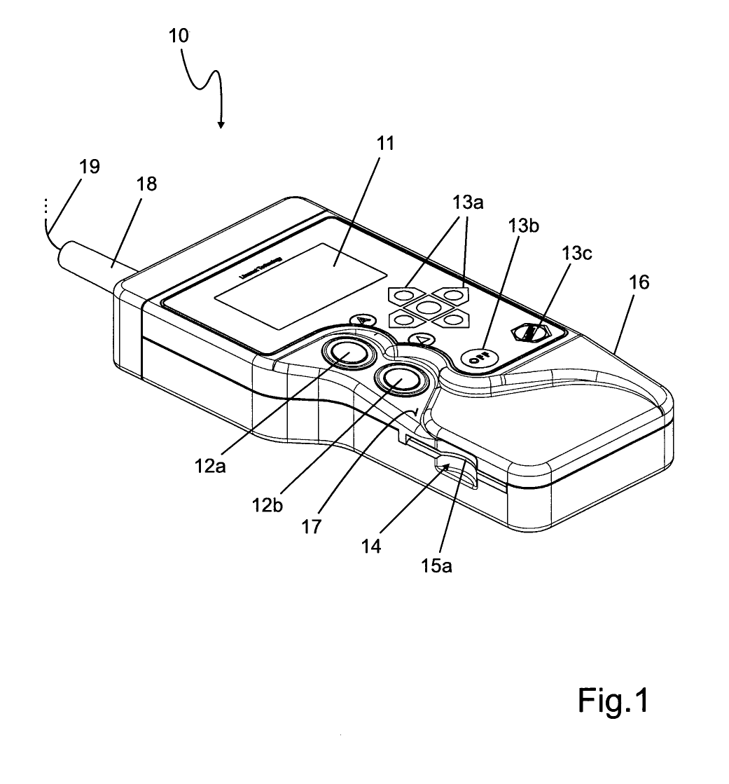

FIG. 1 shows a perspective view from one side and from the rear of a mobile control device for power wrenches 10 according to the invention. The mobile control device for power wrenches 10 comprises a display 11, a first and a second pushbutton 12a, 12b, data membrane keys 13a, a cutoff membrane key 13b and a work light membrane key 13c. The pushbuttons 12a, 12b as well as the membrane keys 13a, 13b, 13c are input elements 12a, 12b, 13a, 13b, 13c of the mobile control device for power wrenches 10.

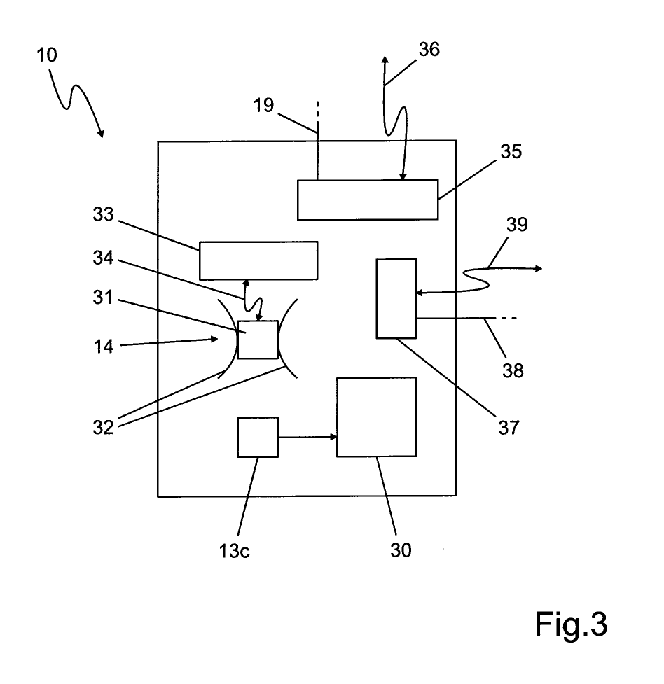

The mobile control device for power wrenches 10 further comprises a receiving mechanism 14 for a contactless mobile data carrier, shown in FIG. 3. The receiving mechanism 14 comprises a first card slot 15a for insertion of the contactless mobile data carrier, which is arranged on a first side of the housing 16 of the mobile control device for power wrenches 10.

In the area of the first and the second pushbuttons 12a, 12b, there can be seen a beveled and/or flatter area 17 on the housing 16 of the mobile control device for power wrenches 10.

An anti-kink sleeve 18 of a first connection line 19 is shown on the forward end of the mobile control device for power wrenches 10. The first connection line 19 leads to a power wrench, shown in FIGS. 14a-14c which will be described later, that is to be operated by the mobile control device for power wrenches 10. The term “operation” is used herein in a broad sense. Apart from the remote operation or remote control of a power wrench and/or the exchange of data with electronic components of a power wrench, additional functions may include the input of data, the storage of data, the display and/or reading-out of data, such as nominal values or actual values, without any contact with the power wrench.

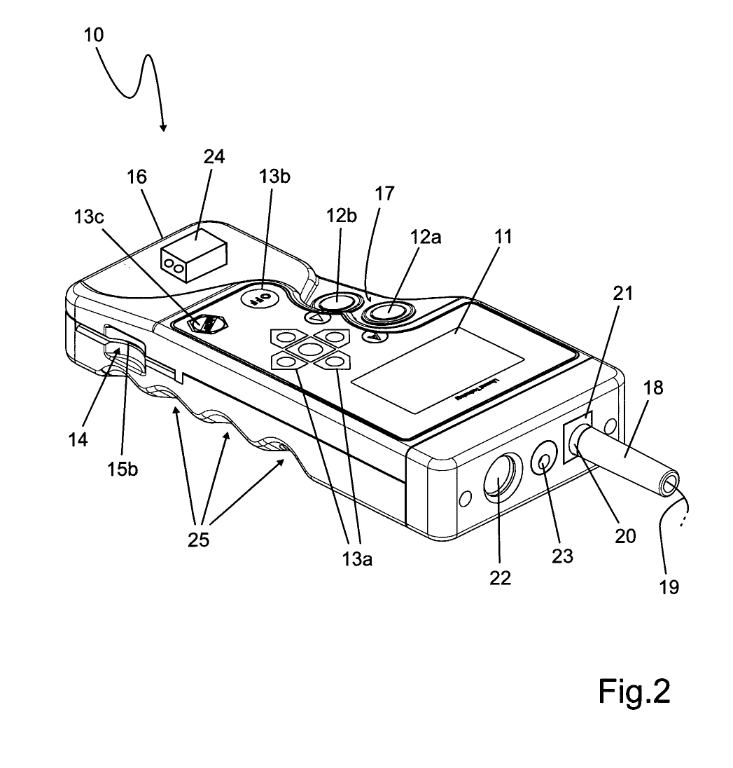

FIG. 2 shows a perspective view from the other side and the forward end of the mobile control device for power wrenches 10 according to the invention. Parts in FIG. 2 that are identical to the parts of FIG. 1 have been marked by the same reference numerals. That convention applies to the other Figures by analogy. FIG. 2 gives a view especially of the forward end of the mobile control device for power wrenches 10, where the first connection line 19 with the anti-kink sleeve 18 is connected according to the first embodiment. For purposes of the illustrated embodiment it is assumed that the first connection line 19 is connected with the mobile control device for power wrenches 10 via a first plug-in connector 20, illustrated in simplified form, using a corresponding plug-in connector 21 also shown in simplified form.

Further, a work light 22, which preferably contains at least one light-emitting diode (LED), is arranged on the front of the mobile control device for power wrenches 10. Such lights, comprising a plurality of light-emitting diodes (cluster LED), which provide comparatively high luminance, meanwhile are available at low cost. An essential advantage of such light-emitting diodes—apart from their high efficiency, which is of considerable importance especially for battery-driven devices—is seen in their long service life as well as their mechanical robustness which is helpful especially under rough environmental conditions where the mobile control device for power wrenches 10 normally is operated.

On the front of the mobile control device for power wrenches 10, there preferably is further provided a plug-in connector 23, configured as a charging socket, to which a charging cable can be connected for charging an accumulator 24 provided as power supply for the mobile control device for power wrenches 10.

FIG. 2 gives a view of the other side of the mobile control device for power wrenches 10 on which a second card slot 15b of the receiving mechanism 14 for the contactless mobile data carrier can be seen. The especially advantageous configuration of the receiving mechanism 14, with card slots 15a, 15b arranged on both sides, provides the essential advantage that any dirt that may have entered the receiving mechanism 14 can be removed by pushing the contactless mobile data carrier through the receiving mechanism 14.

According to another embodiment, recessed grips 25 are formed on one side of the mobile control device for power wrenches 10 according to the invention. Preferably, four recessed grips 25 are provided for four fingers of an operator gripping the mobile control device for power wrenches 10. Preferably, the dimensions of the recessed grips 25 are sized for operators wearing work gloves.

The first and the second pushbuttons 12a, 12b preferably have a specifically defined pressure point. Further, the dimensions of the two pushbuttons 12a, 12b preferably are likewise selected to be suited for operators wearing work gloves, so that a sufficiently large surface area has to be provided. For example, the first pushbutton 12a may have the function to start the power wrench. Pressing the first pushbutton 12a, for example, initiates a forward movement, while a rearward movement should be initiated upon release of the first pushbutton 12a. Further, the first pushbutton 12a may for example have the additional operating function that permanent pressing causes the power wrench to operate automatically. The second pushbutton 12b may, for example, be used for switching off the power wrench.

By having the two pushbuttons 12a, 12b arranged on one side of the mobile control device for power wrenches 10 according to the invention, and the recessed grips 25 arranged on the other side of the housing 16, as shown in the illustrated embodiment, it is possible to hold the mobile control device for power wrenches 10 with one hand and to operate it by the thumb. Ease of handling is further improved by the beveled and/or flatter area 17, if any, in the zone of the first and the second pushbuttons 12a, 12b.

The data membrane keys 13a are provided for programming the mobile control device for power wrenches 10 and/or for the input of data. In the illustrated embodiment, five data membrane keys 13a are shown which may be configured, for example, as “up/down” and “left/right” keys for the selection of menu items or data, and as an acknowledge key. The cutoff membrane key 13b serves to switch off the mobile control device for power wrenches 10 after it has been switched on by operation of any other key. The work light membrane key 13c switches on the work light 22. Preferably, there is further provided a function for switching off the work light 22 automatically after a defined period of time that has been stored in the timing element illustrated in FIG. 3.

FIG. 3 shows a block diagram of the mobile control device for power wrenches 10. The work light membrane key 13c is connected with a timing element 30 that defines a period of time after which the work light will be switched off automatically.

The receiving mechanism 14 for the contactless mobile data carrier 31 preferably comprises at least one spring element 32 for locating the contactless mobile data carrier 31 in the inserted condition in the receiving mechanism 14. In the illustrated embodiment, two spring elements 32 are shown. The spring element 32 can be realized at low cost as a plastic leaf spring, for example.

The mobile control device for power wrenches 10 comprises a data carrier transceiver 33 adapted especially for wireless data carrier connection 34 with the contactless mobile data carrier 31. Exchange of data between the data carrier transceiver 33 and the contactless mobile data carrier 31 takes place when such a data carrier 31 is placed in the receiving mechanism 14. Depending on the configuration of the contactless mobile data carrier 31, the wireless data carrier connection 34 with the contactless mobile data carrier 31 may be effected electromagnetically. In certain special embodiments, emphasis may be placed either on the magnetic field component or on the electric component. In cases where the contactless mobile data carrier 31 does not have an energy source of its own, electric energy can be transmitted also via the wireless data carrier connection 34.

Especially well suited as contactless mobile data carrier 31 is an RFID chip which, being produced by mass production processes, is available at extremely low cost and meets all the requirements of the envisaged application. In that case, the wireless data carrier connection 34 is effected by electromagnetic waves having a defined carrier frequency, for example of 13.56 MHz or, preferably, in the range of 865-869 MHz. The energy supply of the RFID chip likewise is realized via the electromagnetic wave. For the concrete configuration of such an RFID chip, reference is made for example to the prior art cited above so that a detailed description of the RFID technology need not be provided at this point.

The mobile control device for power wrenches 10 further comprises a first control device transceiver 35 to which the first connection line 19 is connected. Instead of the first connection line 19, a first wireless connection 36 on an infra-red base and/or on an ultrasound base and/or on an electromagnetic base may be provided. Low-cost components on an electromagnetic base are available and are known in the market as WLAN components.

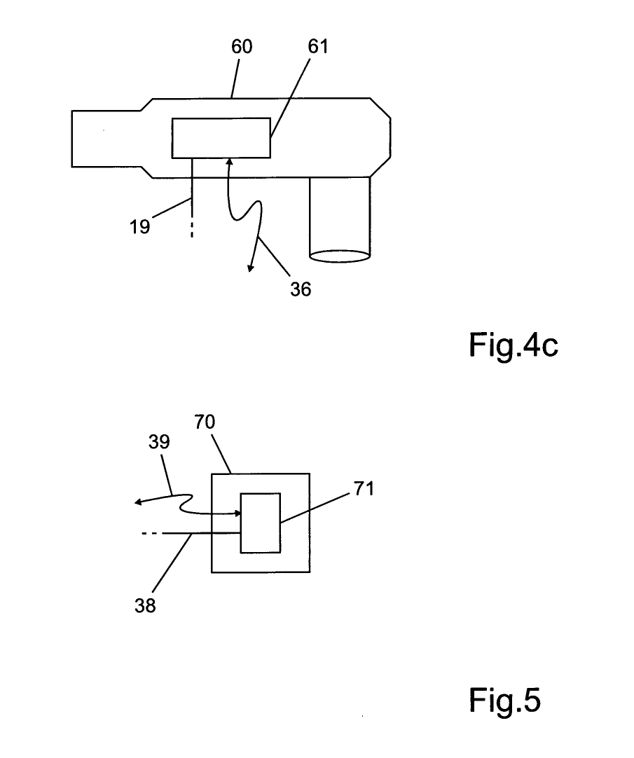

The mobile control device for power wrenches 10 preferably comprises a second control device transceiver 37 intended for the exchange of data with a stationary unit illustrated in FIG. 5. The second control device transceiver 37 provides a second connection line and/or a second wireless connection 39.

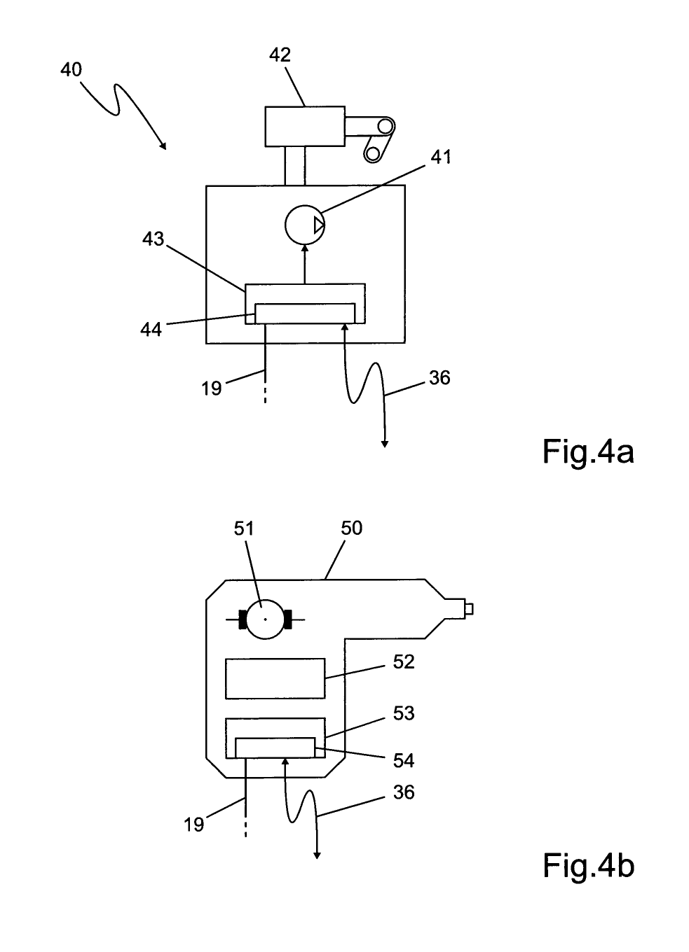

According to a first application, the mobile control device for power wrenches 10 according to the invention is adapted for example for the remote control of a hydraulically or pneumatically operated power wrench 40, shown in FIG. 4a, or for the exchange of data with the power wrench 40. The hydraulically or pneumatically operated power wrench 40 comprises a pressure pump 41 that supplies a pneumatic pressure or a hydraulic pressure to a piston-cylinder unit 42. The hydraulically or pneumatically operated power wrench 40 comprises a control device 43 to which a first power wrench transceiver 44 is assigned. The first connection line 19 may be connected to the first power wrench transceiver 44. Alternatively, or in addition, the first power wrench transceiver 44 may be connected with the mobile control device for power wrenches 10 via the first wireless connection 36.

The first power wrench transceiver 44 of the hydraulically or pneumatically operated power wrench 40 allows both the control of the pressure pump 40 and the exchange of data, i.e. on the one hand of nominal values of a screwed connection specified by the mobile data carrier control device 10, and on the other hand of read-out actual values of a screwed connection produced. Especially the actual values of a screwed connection provided by the hydraulically or pneumatically operated power wrench 40 will be stored, for example, in a storage of the mobile control device for power wrenches 10, not shown in detail, for further documentation and logging.

According to another application, the mobile control device for power wrenches 10 according to the invention is adapted for the remote control of a battery-operated power wrench 50, shown in FIG. 4b, or at least for the exchange of data with the battery-driven power wrench 50. The battery-driven power wrench 50 comprises an electric motor 51 as well as a power wrench battery 52. The battery-driven power wrench 50 further comprises a control device 53 to which a second power wrench transceiver 54 is assigned. The first connection line 19 may be connected to the second power wrench transceiver 54. Alternatively or in addition, the exchange of data with the control device for power wrenches 10 may be effected via the first wireless connection 36.

The second power wrench transceiver 54 allows both the control of the electric motor 51 and especially the exchange of data, i.e. on the one hand of nominal values of a screwed connection to be produced, as specified by the mobile data carrier control device 10, and on the other hand of read-out actual values of a screwed connection produced. To this end, corresponding sensors are required in the battery-driven power wrench 50, such as a torque sensor and/or a rotary sensor. Again, it is important to record the actual values of a screwed connection produced by the battery-driven power wrench 50 for further documentation and logging so that those data preferably are stored in the mobile control device for power wrenches 10.

According to another application, the mobile control device for power wrenches 10 according to the invention is adapted for the exchange of data with a hand-operated power wrench 60. The hand-operated power wrench 60 comprises a third power wrench transceiver 61 to which the first connection line 19 can be connected. Again, the third power wrench transceiver 61 of the hand-operated power wrench 60 can alternatively or additionally exchange data with the mobile control device for power wrenches 10 via the first wireless connection 36.

The mobile control device for power wrenches 10 may for example display data for a screwed connection to be produced by the hand-operated power wrench 60 either on the display 11 of the mobile control device for power wrenches 10 or on a display of the third power wrench transceiver 61—not shown in detail—in the hand-operated power wrench 61. Correspondingly, actual values of screwed connections produced can be input into the mobile control device for power wrenches 10 either directly via the data membrane keys 13a, or can be transmitted to the mobile control device for power wrenches 10 via the first connection line 19 and/or via the first wireless connection 36. However, in that case corresponding sensors, such as a torque sensor or a rotary sensor, are again required in the hand-operated power wrench 60. It is then possible in the case of this application as well to store in the mobile control device for power wrenches 10 especially the actual values of screwed connections produced, for documentation and logging.

The second control device transceiver 37, if provided, in the mobile control device for power wrenches 10 can exchange data with a stationary unit 70, which stationary unit 70 may for example be a larger data processing system adapted to manage date records obtained form a plurality of power wrenches 40, 50, 60. Data are exchanged using a stationary unit transceiver 71 of the stationary unit 70 to which the second connection line 38 can be connected. Alternatively or in addition, data may be exchanged via the second wireless connection 39.

1. Mobile control device for power wrenches comprising at least one display (11) unit and at least one input element (12a, 12b, 13a, 13b, 13c), wherein the control device for power wrenches (10) comprises a receiving mechanism (14) for receiving a contactless mobile data carrier (31) and a data carrier transceiver (33) which establishes a data carrier connection (34) for the exchange of data with a contactless mobile data carrier (31) located in the receiving mechanism (14).

2. The mobile control device for power wrenches as defined in claim 1, wherein the receiving mechanism (14) comprises two oppositely arranged card slots (15a, 15b) that allow the mobile data carrier (31) to be pushed through the mechanism.

3. The mobile control device for power wrenches as defined in claim 1, wherein the receiving mechanism (14) comprises at least one spring element (32) for locating the contactless mobile data carrier (31) in the receiving mechanism (14).

4. The mobile control device for power wrenches as defined in claim 1, wherein the data carrier transceiver (33) is adapted for the exchange-of data with a contactless mobile data carrier (31) in the form of an RFID chip.

5. The mobile control device for power wrenches as defined in claim 1, wherein the mobile control device for power wrenches (10) comprises a work light (22).

6. The mobile control device for power wrenches as defined in claim 5, wherein the work light (22) comprises at least one LED.

7. The mobile control device for power wrenches as defined in claim 5, wherein the mobile control device for power wrenches (10) comprises a timing element (30) that determines the time of persistence of the work light (22).

8. The mobile control device for power wrenches as defined in claim 1, wherein the at least one input element (12a, 12b, 13a, 13b, 13c) is designed as an operating key (12a, 12b) which has a specifically defined pressure point.

9. The mobile control device for power wrenches as defined in claim 1, wherein the at least one input element (12a, 12b, 13a, 13b, 13c) is designed as at least one membrane key (13a, 13b, 13c) for the input of data into the control device for power wrenches (10) or for the control of the mobile control device for power wrenches (10).

10. The mobile control device for power wrenches as defined in claim 1, wherein a beveled and/or a recessed portion (17) is provided on at least one side of the upper surface of the housing (16) of the mobile control device for power wrenches 10.

11. The mobile control device for power wrenches as defined in claim 1, wherein recessed grips (25) are provided on at least one side of the bottom of the housing (17) of the mobile control device for power wrenches (10).

12. The mobile control device for power wrenches as defined in claim 1, wherein the mobile control device for power wrenches (10) comprises a plug-in connector (21) suited to receive a corresponding plug-in connector (20) of a first connection line (19) provided for connecting the mobile control device for power wrenches (10) with a power wrench (40, 50, 60).

13. The mobile control device for power wrenches as defined in claim 1, wherein the mobile control device for power wrenches (10) comprises an accumulator (24) and a plug-in connector (23) designed as a charging socket for the accumulator (24).

14. The mobile control device for power wrenches as defined in claim 1, wherein the mobile control device for power wrenches (10) comprises a first control device transceiver (35) for wireless or wired data exchange with a corresponding power wrench transceiver (44, 54, 61) of a power wrench (40, 50, 60).

15. The mobile control device for power wrenches as defined in claim 1, wherein the mobile control device for power wrenches (10) comprises a second control device transceiver (37) for wireless or wired exchange of data with a corresponding transceiver (71) of the stationary unit, arranged in a stationary system (70).

16. The mobile control device for power wrenches as defined in claim 1, further comprising its use at least for the exchange of data with a hydraulically or pneumatically operated power wrench (40) and/or for the remote control of the hydraulically or pneumatically operated power wrench (40).

17. The mobile control device for power wrenches as defined in claim 1, further comprising its use at least for the exchange of data with a battery-operated power wrench (50) and/or for the remote control of the battery-operated power wrench (50).

18. The mobile control device for power wrenches as defined in claim 1, further comprising its use for the exchange of data with a hand-operated power wrench (60), or for the output and/or input of data of the hand-operated power wrench (60) only on the control device for power wrenches (10).
